(19) United States
(12) Patent Application Publication
(10) Pub. No.: US 2014/0339162 A1
(43) Pub. Date: Nov. 20, 2014

(54) BORON REMOVAL FROM OILFIELD WATER

(71) Applicant: BAKER HUGHES INCORPORATED, HOUSTON, TX (US)

(72) Inventors: JIASHENG CAO, THE WOODLANDS, TX (US); RONALD M. MATHERLY, SUGAR LAND, TX (US); DARYL D. MCCRACKEN, HOUSTON, TX (US); KUSHAL SETH, HOUSTON, TX (US)

(73) Assignee: BAKER HUGHES INCORPORATED, HOUSTON, TX (US)

(21) Appl. No.: 14/264,877

(22) Filed: Apr. 29, 2014

Related U.S. Application Data
(63) Continuation-in-part of application No. 13/972,545, filed on Aug. 21, 2013.
(60) Provisional application No. 61/824,456, filed on May 17, 2013.

(51) Int. Cl. C02F 9/00; C02F 1/44; C02F 1/40; C02F 1/463; C02F 1/28

(52) U.S. Cl. CPC C02F 9/00; C02F 1/463; C02F 1/281; C02F 1/40; C02F 1/44; C02F 2103/10
USPC 210/638; 205/746; 204/252; 210/243

(57) ABSTRACT

Electrocoagulation (EC) may remove oil and solids from oilfield water and other raw, untreated or unprocessed water as a pretreatment for increased boron removal efficiency using a subsequent boron selective resin. Boron selective resins are efficient for boron removal, but oil and solids in water lower the boron remove efficiency and capacity.

### CROSS-REFERENCES TO RELATED APPLICATIONS

This application claims the benefit of U.S. Provisional Patent Application Ser. No. 61/824,456 filed May 17, 2013, and this application is also a continuation-in-part application of U.S. Ser. No. 13/972,545 filed Aug. 21, 2013, both of which are incorporated herein in their entirety by reference.

### TECHNICAL FIELD

The present invention relates to methods and apparatus for removing boron from water and more particularly relates to methods and apparatus for removing boron from untreated water, such as, but not limited to, oilfield produced water and flowback water.

### TECHNICAL BACKGROUND

Water is a valuable resource. Many oil and natural gas production operations generate, in addition to the desired hydrocarbon products, large quantities of waste water, referred to as “produced water”. Produced water is typically contaminated with significant concentrations of chemicals and substances requiring that it be disposed of or treated before it can be reused or discharged to the environment. Produced water includes natural contaminants that come from the subsurface environment, such as hydrocarbons from the oil- or gas-bearing strata and inorganic salts. Produced water may also include man-made contaminants, such as drilling mud, “frac flow back water” that includes spent fracturing fluids including polymers and inorganic cross-linking agents, polymer breaking agents, friction reduction chemicals, and artificial lubricants. These contaminants are injected into the wells as part of the drilling and production processes and recovered as contaminants in the produced water.

There are several commonly encountered non-natural contaminants in produced water; which contaminants and their sources are next discussed.

From high-viscosity fracturing operations—gellants in the form of polymers with hydroxyl groups, such as guar gum or modified guar-based polymers; cross-linking agents including borate-based cross-linkers; non-emulsifiers; and sulfate-based gel breakers in the form of oxidizing agents such as ammonium persulfate. From drilling fluid treatments—acids and caustics such as soda ash, calcium carbonate, sodium hydroxide and magnesium hydroxide; bactericides; defoamers; emulsifiers; filtrate reducers; shale control inhibitors; deicers including methanol and thinners and dispersants. From slickwater fracturing operations—viscosity reducing agents such as polymers of acrylamide.

It may be seen that there is a very wide range of contaminant species and that the quality of produced water from different sources can vary markedly. Much effort has been expended to create a cost effective treatment system that can treat or recycle the spectrum of possible produced water streams. For example, while reverse osmosis is effective in treating many of the expected contaminants in produced water, it is not very effective in removing methanol and it may be fouled by even trace amounts of acrylamide.

As another example, there have been many attempts to reclaim produced water and reuse it as fracturing feed water, commonly referred to as “frac water”. Frac water is a term that refers to water suitable for use in the creation of fracturing (frac) gels which are used in hydraulic fracturing operations. Frac gels are created by combining frac water with a polymer, such as guar gum, and in some applications a cross-linker, typically borate-based, to form a fluid that gels upon hydration of the polymer. Several chemical additives generally will be added to the frac gel to form a treatment fluid specifically designed for the anticipated wellbore, reservoir and operating conditions.

One problem occurs when the produced water is contaminated with boron, such as from the use of borate-based cross-linking agents, and it is desirable to discharge the water to the environment. One way to treat produced water with boron is referred to as the HERO® process in which the pH is raised up to at least about 11 prior to treatment with reverse osmosis, resulting in the boron being rejected with the reverse osmosis reject brine. However, raising the pH has several undesirable attributes. First, there is increased scaling within the reverse osmosis system increasing the maintenance costs of the system. Second, the pH must then be reduced before the treated water may be discharged to the environment. Third, the cost of the chemicals to raise the pH coupled with the cost of immediately thereafter lowering the pH and the cost of disposal of the precipitated salts resulting from the lowering of the pH make the HERO® process very expensive.

However, it is not always necessary to remove all of the boron if the produced water is to be reused as frac water or for applications or purposes that do not require highly pure water. It may only be necessary to remove enough of the boron so that when the treated water is re-used as frac water that the level of boron present does not adversely interfere with the purposes of the frac water, for instance, premature crosslinking the polymer in the water before it is introduced downhole and placed adjacent the subterranean formation desired to be fractured.

Boron selective resin has been used commercially to remove boron from different water types, such as drinking water, ground water, waste water, irrigation water and industry water. The boron removal efficiency using these resins depends on the initial boron concentration; the lower the boron initial concentration, the higher the boron removal efficiency and capacity. However, when treating oil water to remove boron using a boron selective resin, oil and total suspended solids (TSS), or total dissolved solids (TDS), reduce the boron selective resin efficiency and capacity for boron removal.

It would thus be very desirable to discover relatively simple and inexpensive methods and apparatus for reducing the level of boron in water, particularly quickly and easily reducing the level of boron in water while not necessarily removing all of the boron or purifying the water.

### SUMMARY

There is provided, in one non-limiting form, a method of at least partially removing boron from untreated water containing boron, where the method involves treating the untreated water with an electrocoagulation apparatus to give an effluent, and treating the effluent with a boron selective polymer resin to give reduced-boron content water.

Additionally there is provided in one non-restrictive version a system for at least partially removing boron from untreated water containing boron, where the system includes an electrocoagulation apparatus and a boron selective polymer resin. The electrocoagulation apparatus may include at least one inlet configured to allow untreated water to flow into the apparatus; at least one outlet configured to allow an effluent to flow from the housing; first and second electrodes disposed within the apparatus between the at least one inlet and the at least one outlet and spaced apart from one another, each of said first and second electrodes being directly connected to a source of electric power; and a sacrificial module having multiple fluid flow passageways therein. The sacrificial module is configured to be positioned in the apparatus between said first and second electrodes and not directly connected to a source of electric power, the sacrificial module including sacrificial metallic material that dissolves during electrocoagulation treatment of the untreated water and being configured to be movable into and out of said housing as a single unit. The boron selective polymer resin includes an inlet to receive the effluent from the electrocoagulation apparatus and an outlet to give reduced-boron content water.

### BRIEF DESCRIPTION OF THE DRAWINGS

The following Figures are part of the present specification, included to demonstrate certain aspects of various embodiments of this disclosure and referenced in the detailed description herein:

FIG. 1 is a schematic diagram of an exemplary electrocoagulation system which includes an embodiment of a sacrificial module in accordance the present disclosure;

FIG. 2 is a perspective view of one non-limiting embodiment of a sacrificial module having multiple coil spring-like members shown disposed between a pair of electrodes in accordance with the present disclosure;

FIG. 3 is a top view of the sacrificial module of FIG. 2;

FIG. 4 is a perspective view of an embodiment of a sacrificial module including corrugated sheet-like sacrificial members shown disposed between a pair of electrodes in accordance with the present disclosure;

FIG. 5 is a top view of the sacrificial module of FIG. 4;

FIG. 6 is a perspective view of an embodiment of a sacrificial module having accordion-like sacrificial members shown disposed between a pair of electrodes in accordance with the present disclosure;

FIG. 7 is another perspective view of the sacrificial module of FIG. 6;

FIG. 8 is a top view of an embodiment of a sacrificial module having disc spring-like sacrificial members shown disposed between a pair of electrodes in accordance with the present disclosure;

FIG. 9 is a perspective view of the sacrificial module of FIG. 8;

FIG. 10 is a top view of an embodiment of a sacrificial module having tube-like sacrificial members shown disposed between a pair of electrodes in accordance with the present disclosure;

FIG. 11 is a top view of another embodiment of a sacrificial module having tube-like sacrificial members shown disposed between a pair of electrodes in accordance with the present disclosure;

FIG. 12 is a perspective view of an embodiment having multiple sacrificial modules in the form of hollow tubes shown disposed between a pair of electrodes in accordance with the present disclosure;

FIG. 13 is a perspective view of another embodiment having multiple sacrificial modules in the form of hollow tubes shown disposed between a pair of electrodes in accordance with the present disclosure;

FIG. 14 is a perspective view of an embodiment having multiple sacrificial modules in the form of carriers which contain freely moving objects in the form of aluminum cans;

FIG. 15 is a top view of the embodiment of FIG. 14;

FIG. 16 is a perspective view of an embodiment having multiple sacrificial modules in the form of carriers which contain freely moving objects in the form of metal shavings;

FIG. 17 is a top view of the embodiment of FIG. 16;

FIG. 18 is a perspective view of an embodiment having multiple sacrificial modules in the form of carriers which contain freely moving objects in the form of spheres;

FIG. 19 is a top view of the embodiment of FIG. 18;

FIG. 20 is a schematic diagram of the method for at least partially removing boron from untreated water as described herein;

FIG. 21 is a graph of boron removal from three water samples as a function of the amount of resin used;

FIG. 22 is a graph of boron removal from samples of raw produced water and electrocoagulation treated water as a function of the amount of resin used; and

FIG. 23 is a graph illustrating the change in boron concentration as a function of different effluent volume for Example 3.

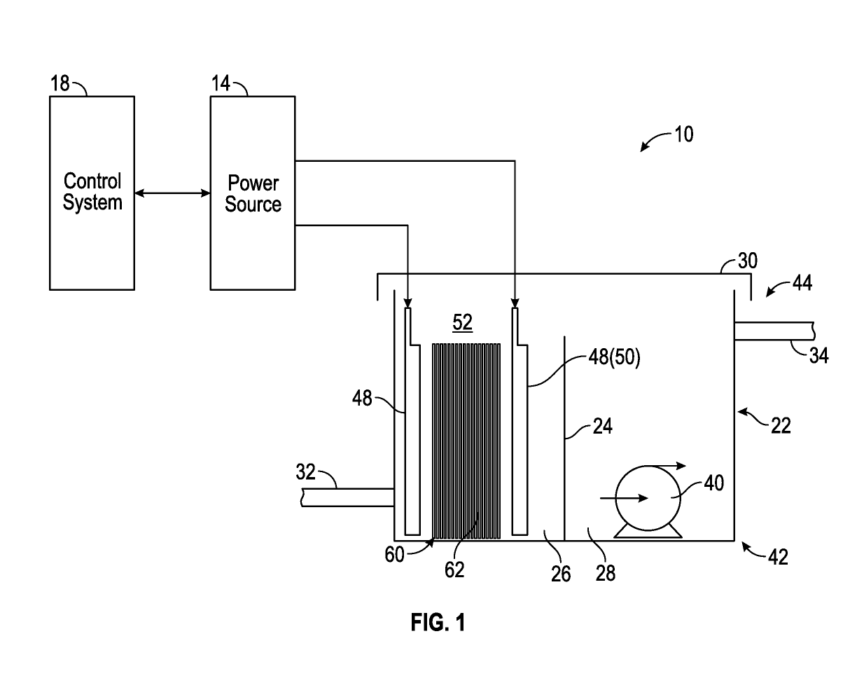

It will be appreciated that FIGS. 1-20 are schematic illustrations which are not necessarily to scale and that certain features are exaggerated for clarity, and thus the methods and apparatus described herein should not be limited by the drawings.

### DETAILED DESCRIPTION

It has been discovered that electrocoagulation removes suspended solids and oil from oil produced water, flowback water, and slick water. It has also been discovered that electrocoagulation lowers boron concentration from water. It has been further surprisingly found that electrocoagulation could treat untreated or raw water, such as an oil water sample to remove oil, suspended solids, and lower boron concentration, to increase boron removal efficiency with boron selective resin in a subsequent treatment step or procedure.

Characteristics and advantages of the present disclosure and additional features and benefits will be readily apparent to those skilled in the art upon consideration of the following detailed description of exemplary embodiments of the present disclosure and referring to the accompanying Figures. It should be understood that the description herein and appended drawings, being of example embodiments, are not intended to limit the claims of this patent application, any patent granted hereon or any patent or patent application claiming priority hereto. On the contrary, the intention is to cover all modifications, equivalents and alternatives falling within the spirit and scope of the claims. Many changes may be made to the particular embodiments and details disclosed herein without departing from such scope.

In showing and describing preferred embodiments, common or similar elements are referenced in the appended Figures with like or identical reference numerals or are apparent from the Figures and/or the description herein. The Figures are not necessarily to scale and certain features and certain views of the Figures may be shown exaggerated in scale or in schematic form in the interest of clarity and conciseness.

As used herein and throughout various portions (and headings) of this patent application, the terms “invention”, “present invention” and variations thereof are not intended to mean every possible embodiment encompassed by this disclosure or any particular claim(s). Thus, the subject matter of each such reference should not be considered as necessary for, or part of, every embodiment hereof or of any particular claim(s) merely because of such reference. The terms “coupled”, “connected”, “engaged”, “carried” and the like, and variations thereof, as used herein and in the appended claims are intended to mean either an indirect or direct connection or relationship, unless otherwise specified. For example, if a first device couples to a second device, that connection may be through a direct connection, or through an indirect connection via other devices and connections.

Certain terms are used herein and in the appended claims to refer to particular components. As one skilled in the art will appreciate, different persons may refer to a component by different names. This document does not intend to distinguish between components that differ in name but not function. Also, the terms “including” and “comprising” are used herein and in the appended claims in an open-ended fashion, and thus should be interpreted to mean “including, but not limited to . . . ”. Further, reference herein and in the appended claims to components and aspects in a singular tense does not necessarily limit the present disclosure or appended claims to only one such component or aspect, but should be interpreted generally to mean one or more, as may be suitable and desirable in each particular instance.

In more detail, electrocoagulation was discovered to be useful to treat oil water sample containing boron, oil, and other ions. However, it should be understood that while electrocoagulation may remove some boron and other ions, it is not necessary that the electrocoagulation remove any boron or other ions for the method and apparatus described herein to be successful. After the electrocoagulation pre-treated water settled, the top clear water was collected and treated with boron selective resin. The boron selective polymer resin may be commercial resin purchased from manufacturer and used as it is.

It is emphasized that the initial water being treated in one non-limiting embodiment may be raw or untreated water, including but not necessarily limited to, ground water, waste water, irrigation water, industry water, oilfield produced water, and flowback water from hydraulic fracturing fluids selected from the group consisting of slickwater fracturing fluids, linear polymer fracturing fluids, and crosslinked polymer fracturing fluids.

Goals of the method and apparatus described herein include, but are not necessarily limited to, reducing the concentration of oil, boron, iron ions and hardness. In a non-restrictive instance, the untreated water may be surface water with high concentration of boron, fresh or brackish ground water with high boron levels, any produced water including but not limited to flow back water from slickwater, linear, crosslinked frac fluid systems, and the like.

In one non-limiting embodiment, the untreated water may have a composition falling within the parameters of Table I.

TABLE I
Permissible Untreated Water Composition

| Component | Proportion | |
|---|---|---|
| Boron | Greater than 140 | mg/L |
| Methanol | None | |
| Iron | 0-125 | mg/L |
| Hardness | Greater than 1000 | mg/L |
| TDS | 10,000-250,000 | mg/L |

As noted, it is not necessary that all of the contaminants addressed be completely removed from the water for the method and apparatus herein to be considered successful. For instance, it may only be necessary to reduce enough of the contaminant so that it does not adversely interfere with the next use of the water. In the case of boron, if the reduced-boron content water has the boron concentration reduced to a sufficient extent that it does not interfere with the use of the water as frac water, for instance that it does not prematurely crosslink the polymer in the water to a problematic extent, this may be sufficient. In one non-limiting embodiment the resulting reduced-boron content water may contain less than 50 mg/L boron, alternatively less than 10 mg/L boron. A non-limiting goal may be to reduce boron levels sufficient to reuse the water in other oilfield applications. Of course, it is acceptable if all, or essentially all, of the contaminants are removed, for instance if all of the boron is removed. Alternatively, the initial untreated water may contain more than 100 mg/L boron; in a different non-limiting embodiment, the initial untreated water may contain more than 150 mg/L of boron.

With respect to the electrocoagulation apparatus, the apparatus may have electrodes that are non-consumable, and in a specific case, the non-consumable electrodes comprise noble metal-coated titanium. Suitable noble metals include, but are not limited to, ruthenium, rhodium, palladium, silver, osmium, iridium, platinum, gold, and combinations and alloys thereof. As will be discussed in more detail below, the electrocoagulation apparatus may comprise a sacrificial metal, such as but not limited to, aluminum in various forms, including, but not necessarily limited to, reclaimed aluminum cans. The sacrificial metal may include, but not necessarily be limited to, aluminum, iron, magnesium, mixtures of these metals with other metals not of this group, and/or alloys of these metals with other metals not of this group. Further, the electrocoagulation apparatus may treat the untreated water with a voltage between the electrodes of up to 200 volts and a current between the electrodes of up to 1000 amps. Alternatively, the voltage may range from about 20 independently to about 30 volts, and the amperage may range from about 500 independently up to about 800 amps.

The method and apparatus may use a boron selective polymer resin having an average particle size between about 300 independently to about 1200 microns; alternatively from between about 354 independently to about 1190 microns; and in another non-limiting embodiment from about 300 independently to about 850 microns. An alternative particle size lower threshold may be 425 microns. When the word “independently” is used herein with respect to a range, it is intended that any lower threshold may be used together with any upper threshold to create a valid, suitable alternative range.

The boron selective polymer resin may be a free base macroporous commercial boron selective resin. The boron selective polymer resin may comprise any suitable polymer, including, but not necessarily limited to, polystyrene crosslinked with divinylbenzene, also called styrene-divinylbenzene, S-DVB or Sty-DVB. Suitable specific boron selective polymer resins include, but are not necessarily limited to, RESINTECH SIR 150 resin, which is a S-DVB ion exchange resin having a particle size between 354 and 1190 microns, and PUROLITE S110 resin which is a S-DVB ion exchange resin having a particle size between 300 and 850 microns. In one non-limiting embodiment, the particle size is between 425 independently to 630 microns, where 95% of the particles in this range are removed, and 5% or less of the particles smaller than 425 microns are retained. The boron selective polymer resin may have a coating that removes or assists in removing boron. Acceptable coatings include, but are not necessarily limited to, n-methylglucamine, and the like, and combinations thereof.

The method from the introduction of the untreated water to the end result of giving reduced-boron content water is relatively very short, and for instance may be a total residence time of less than 30 minutes, alternatively less than 60 minutes; in another non-limiting embodiment less than two hours. This is in contrast to more involved and complex methods and apparatus which may have a residence time of many hours to many days, but which produce purer water.

In another non-limiting embodiment, after the water is treated by the electrocoagulation (EC) apparatus, the method includes settling the effluent for a period of time between about 10 independently to about 60 minutes, alternatively from about 30 independently to about 40 minutes and drawing off a top layer prior to treating the effluent with the boron selective polymer resin.

In another non-restrictive version, the flow ranges may range from about 100 gallons/minute independently to about 300 gallons/minute.

Even more specifically with respect to the electrocoagulation apparatus and referring to FIG. 1, an example electrocoagulation system 10 for use in removing contaminants from liquid is shown including a power source 14, controller 18 and electrocoagulation cell, or housing, 22. The power source 14, controller 18 and electrocoagulation cell 22 may have any suitable components, construction, configuration and operation as is or becomes further known. For example, the illustrated power source 14 may be one or more diesel generator (not shown) and the control system 18 may include one or more computer and/or electronic controller. In this example, the electrocoagulation cell 22 is a large container constructed of non-electrically conductive material, such as plastic.

The illustrated exemplary cell 22 is divided, such as by at least one baffle 24, into a reaction chamber 26 and a secondary chamber 28 and includes a removable cover 30, at least one fluid inlet 32 and at least one fluid outlet 34. The illustrated inlet 32 is located proximate to the lower end 42 of the cell 22 and the outlet 34 is located proximate to the upper end 44 of the cell 22. The illustrated reaction chamber 26 includes a pair of electrodes 48 spaced apart by a gap 52 and each connected to the power source 14. One of the electrodes 48 acts as an anode and the other acts as a cathode. The power source 14 provides electric current to the electrodes 48. In this example, the control system 18 is used to set the appropriate amperage and voltage of the power source 14.

As is known, contaminated liquid, such as salt water brine, enters the exemplary cell 22 through the inlet 32 and is treated in the reaction chamber 26. When the liquid is present in the gap 52 between the electrodes 48, electric current flows from the anode 48 to the cathode 48 (also noted in FIG. 1 as 50) through the liquid, ultimately causing the removal of contaminants from the liquid via electrocoagulation. The resulting liquid passes into the secondary chamber 28 and is pumped, via at least one pump 40, such as a centrifugal pump or sump pump, out of the cell 22 through the outlet 34. Resulting gas, usually in the form of oxygen and hydrogen bubbles, is typically released and resulting solids typically fall to the bottom of the reaction chamber 26. However, this precise arrangement is not required. For example, multiple sets of electrodes 48 and/or multiple chambers 26, 28 may be included and a secondary chamber 28 and/or pump 40 may not be included.

It should be understood that the above-referenced components and features may have any other suitable form, construction, configuration and operation as is or becomes further know. Further, additional or different components may be included. Moreover, the above-referenced components are not limiting upon or required for the present disclosure, the appended claims or the claims of any patent application or patent claiming priority hereto, except and only to the extent that they are expressly required in a particular claim. Accordingly, the subject matter of the present disclosure, one or more embodiments of which will be described below, may be used in connection with a boron removal method using an electrocoagulation system 10 that does or does not include all of the above-described components, features or capabilities, and may have additional or different components.

Still referring to FIG. 1, in accordance with an embodiment of the present disclosure, at least one sacrificial module 60 is shown disposed in the gap 52 between the electrodes 48 and not directly connected to the power source 14. The illustrated sacrificial module 60 includes sacrificial metallic material 62 that will be exposed to the contaminated liquid as it passes through the gap 52 and which dissolves during, or provides sacrificial metal ions necessary for electrocoagulation treatment of the liquid. A few examples of sacrificial metallic material which may be used in the module 60 are iron and aluminum. However, other suitable metallic materials, or combinations of materials, may be used.

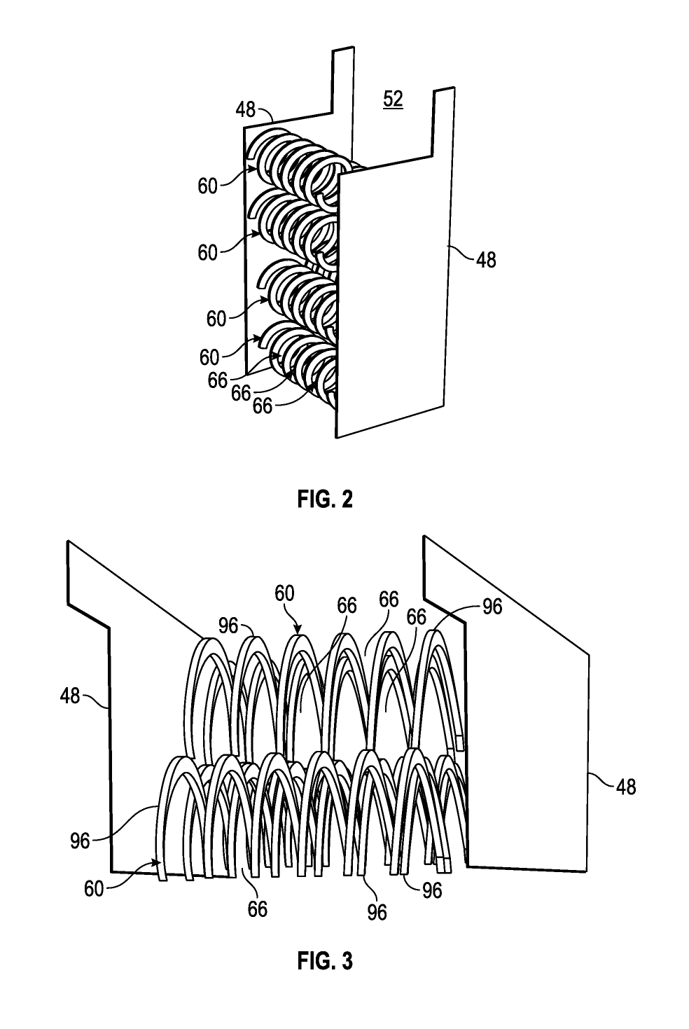

It should be noted that, while a single pair of electrodes 48 and a single corresponding module 60 is shown and described in connection with this embodiment, multiple pairs of electrodes 48 and corresponding modules 60 may be included. Further, more than one module 60 may be disposed between a single pair of electrodes 48. If desired, multiple sets of electrodes 48 and sacrificial modules 60 may be included in the same or multiple reaction chambers 26. Further, multiple sacrificial modules 60 may be included between a single set of electrodes 48. For example, the embodiment of FIGS. 2 and 3 includes multiple non-interconnected modules 60, each formed in a coil spring configuration with coils 96 and disposed between the electrodes 48.

In a preferred embodiment, the electrodes 48 may be non-sacrificial, or configured not to dissolve or provide sacrificial metal ions during electrocoagulation treatment. For example, the electrodes 48 may be passivated or constructed of or coated with one or more noble metal material, such as ruthenium, rhodium, palladium, silver, osmium, iridium, platinum, and/or gold, or include one or more oxidation-resistant and corrosion-resistant material, such as diamond or graphite. Consequently, in use of this embodiment during electrocoagulation treatment of liquid in the reaction chamber 26, the sacrificial metallic material 62 of the module 60 will preferably dissolve, preserving the integrity of the electrodes 48. In such instances, it may not be necessary to remove and clean or replace the electrodes 48. However, this feature is not required and, in other embodiments, the electrodes 48 may also include sacrificial metallic material.

If desired, more than one inlet 32 and/or more than one outlet 34 may be included in the cell 22. Further, the inlet(s) 32 and outlet(s) 34 may be positioned at any desired location in the cell 22. For example, the system 10 may be arranged so that contaminated liquid flows sideways in the reaction chamber 26 from the inlet(s) 32 and into the gap 52 (not shown).

Still referring to FIG. 1, the sacrificial module 60 may have any suitable construction, configuration and form. In one independent aspect, the exemplary sacrificial module 60 may be configured to be movable into and out of the cell 22 as a single unit. As a single unit not connected with the power source 14, the illustrated module 60 is easily removable from the cell 22 and replaceable, such as when the sacrificial metallic material 62 dissolves sufficiently to warrant the replacement thereof. For example, in some applications, the module 60 may be gripped by a crane (not shown) or other lifting equipment to be lifted into and out of the cell 22.

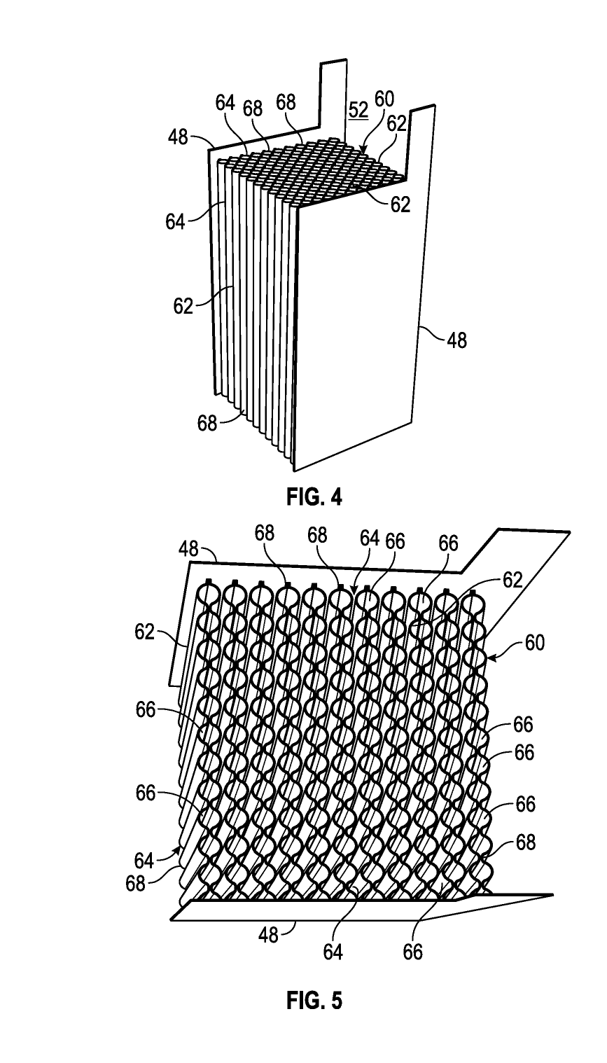

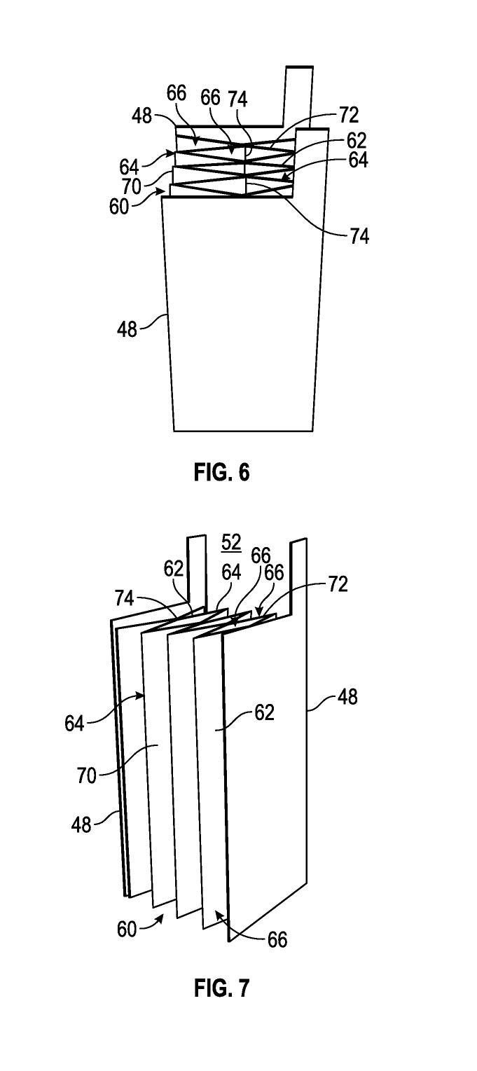

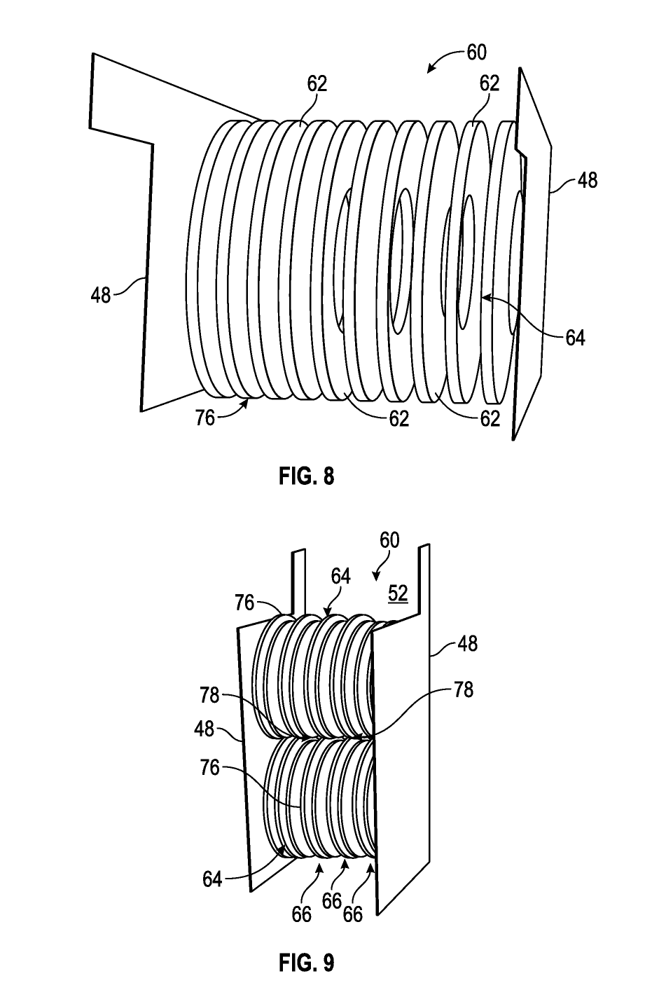

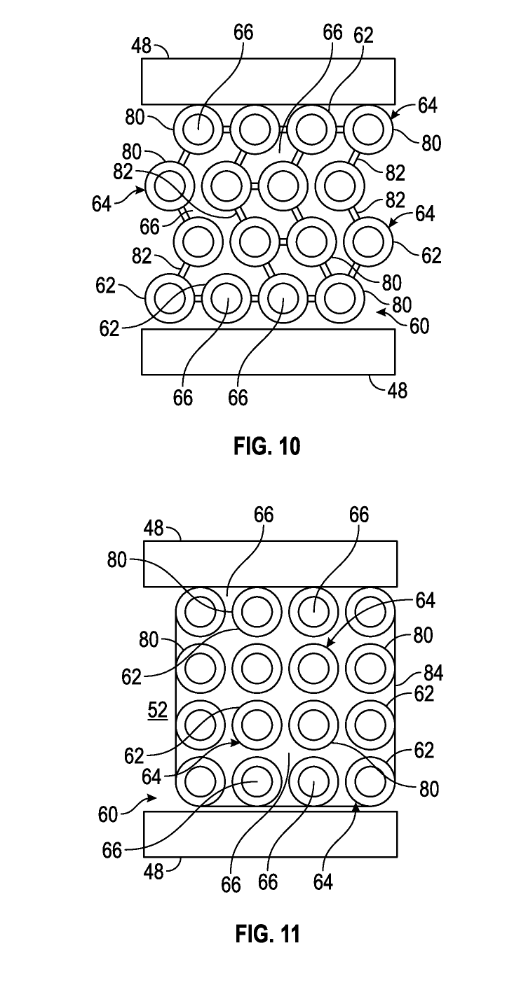

In some embodiments, the sacrificial module 60 may include multiple sacrificial members 64 which include the sacrificial metallic material 62 and are connected together. For example, in the embodiment of FIGS. 4 and 5, the sacrificial members 64 are corrugated metal sheets 68 which are welded together to form a unitary module 60. In FIGS. 6 and 7, the sacrificial members 64 are a pair of folded sheets 70, 72 of conductive metal that are welded together at multiple seams 74 to form an accordion-like configuration. In FIG. 10, the sacrificial members 64 are hollow tubes 80 which are welded together at welds 82. If desired, the welds may include or be coated with non-conductive material, such as rubber or plastic polymer, to preserve the interconnection of the sacrificial members 64 after the sacrificial metallic material 62 begins to dissolve during electrocoagulation.

When multiple sacrificial members 64 are included in the sacrificial module 60, they may be interconnected in any other suitable manner, such as with bolts, rivets, clips or other connectors (not shown). Likewise, such other connectors may be constructed of or coated with non-conductive material. In FIGS. 8 and 9, for example, the module 60 includes a pair of sacrificial members 64, each formed as a disc spring 76 and interconnected with a series of plastic clips 78. In yet other embodiments, the module 60 may include multiple sacrificial members 64 held together around their peripheries, such as with one or more conductive or non-conductive ring, strap or band. For example, the module 60 of FIG. 11 includes multiple sacrificial members 64 formed as hollow tubes 80 and held together with one or more plastic straps 84.

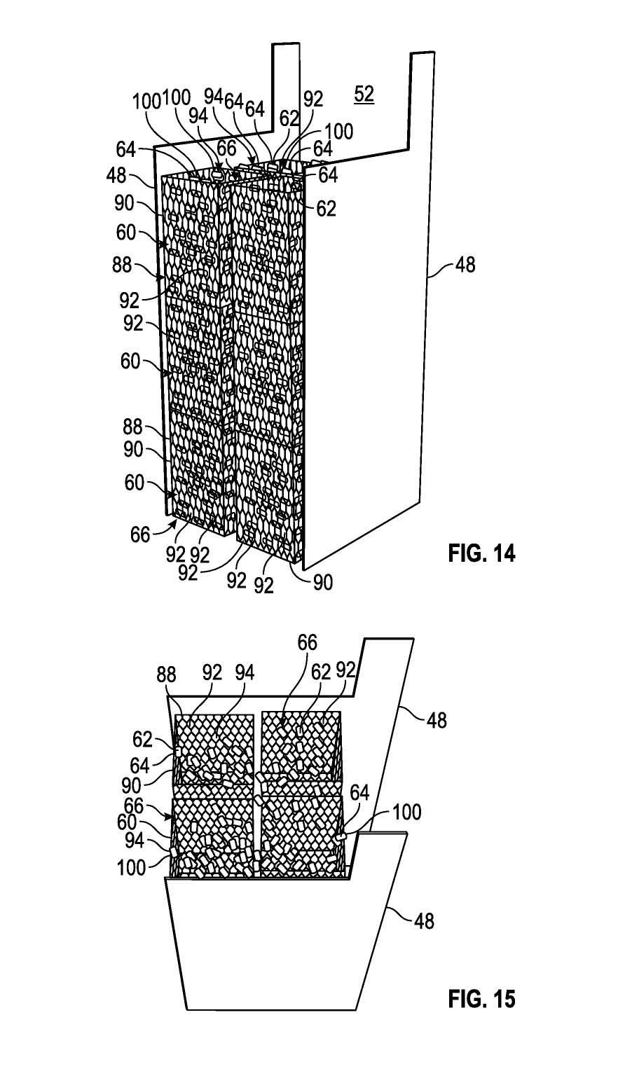

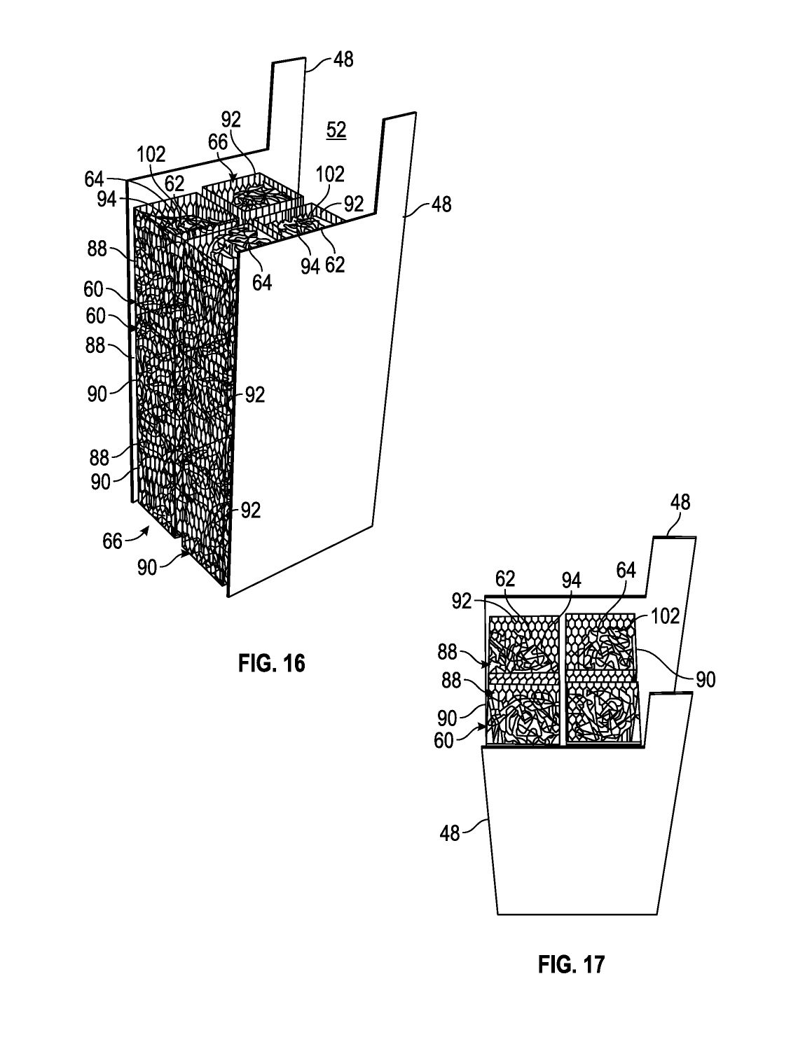

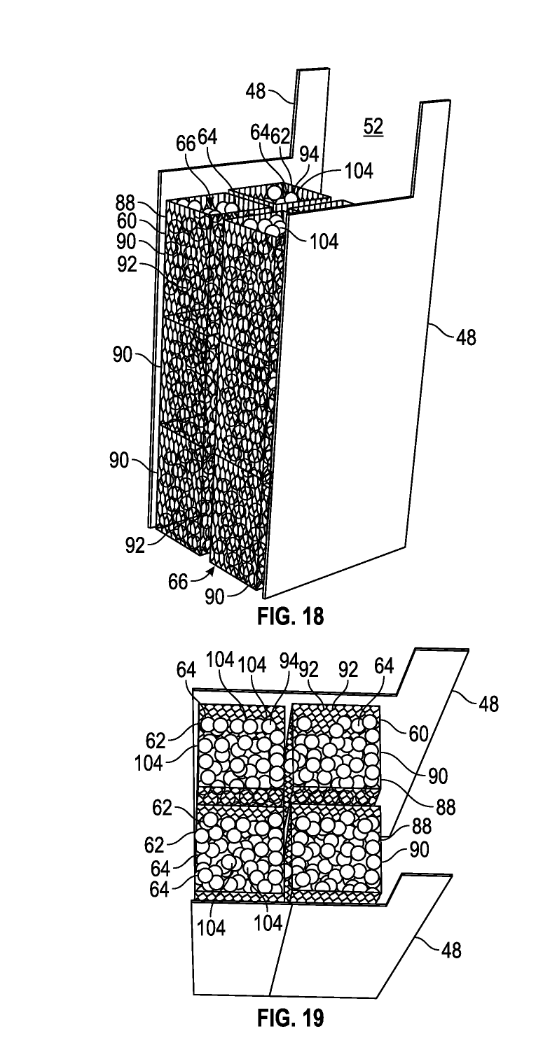

In other embodiments, the module 60 may include a single sacrificial member 64 formed in a continuous mass, such as, for example, a single folded, helical, coiled or twisted piece of conductive metal (not shown). In still other embodiments, referring to FIG. 14, the module 60 may include one or more carrier 88 that can be gripped for movement into and out of the cell 22. In the embodiment of FIGS. 14-19, the carriers 88 are cages 90 constructed of non-conductive material, such as plastic, that has multiple openings 92 and contain multiple sacrificial members 64. The sacrificial members 64 may have any suitable form, construction and configuration. For example, the sacrificial members 64 may be freely moving metal objects 94 that include one or more metallic surfaces. Some examples of such objects 94 are aluminum cans 100 or other metallic containers (e.g. FIGS. 14-15) which may or may not be crushed, shredded aluminum, metal shavings 102 (e.g. FIGS. 16-17), beads, pellets, spheres 104 (e.g. FIGS. 18-19), balls, squares, rings or the like, constructed at least partially of one or more metallic material, not necessarily aluminum. Aluminum is used as one non-limiting example of a sacrificial metal in this specification. In another example, the carrier 88 may be a bag constructed of suitable strength non-conductive material, such as a porous or fluid-permeable woven or mesh fabric bag or perforated plastic sack (not shown), which contains freely moving metal objects 94. In yet other embodiments, the carrier 88 may include a single sacrificial member 64 or multiple interconnected sacrificial members 64. If desired, the carrier 88 may be constructed of one or more material that naturally attracts oil, such as TEFLON® or polyethylene.

Any other suitable shape and configuration of sacrificial module(s) 60 and sacrificial member(s) 64 may be included, such as a vortex shaped module 60 (not shown) or spiral or helically-shaped members 64 (not shown), such as to assist in the separation of contaminants from the liquid during electrocoagulation. Further, the module(s) 60 or member(s) 64 may have any desired thickness or surface texture. For example, the sacrificial metallic material 62 may be formed with a minimal, consistent thickness, such as to maximize its surface area for contact with contaminated liquid and/or to optimize measurability of surface area or volume. For other examples, the module(s) 60 or member(s) 64 may be at least partially formed with a non-smooth, rough or textured surface, such as to increase the agitation of the liquid flowing thereby or formation of gas bubbles during electrocoagulation treatment. For yet another example, the module(s) 60 or member(s) 64 may be at least partially perforated, fluid permeable or porous, such as to increase the surface area of the sacrificial metallic material 62 for contact with the contaminated liquid or enhance flow or agitation of fluid flowing thereby.

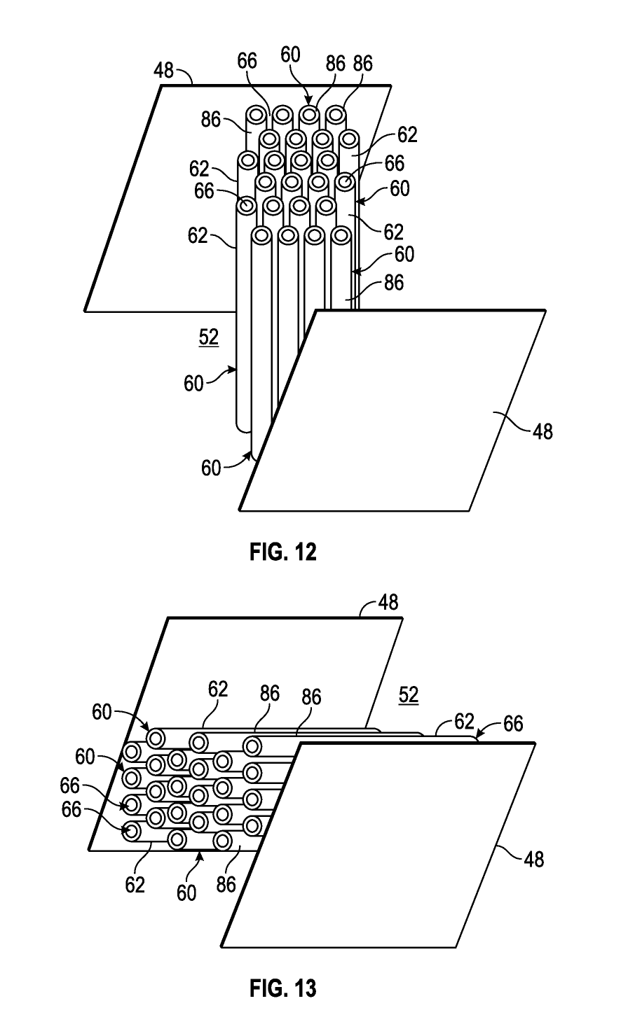

In another independent aspect, the sacrificial module 60 may be configured to be evaluated after it is placed within the housing 22, such as to assist in optimizing electrocoagulation effectiveness and efficiency. For example, the sacrificial metallic material 62 of the module 60 may have a measurable surface area, weight, volume or combination thereof. The ability to measure one or more of these variables could be useful (i) to measure consumption of the sacrificial metallic material 62 and determine when the module(s) 60 should be replaced, and/or (ii) to determine current density of power being supplied from the power source 14 to the electrodes 48. In some embodiments, such as the examples of FIGS. 1, 10, 11 and 14, the module(s) 60 may be engaged with a scale (not shown) and weighed at a desired or pre-established time after it is disposed in the cell 22. For example, after some duration of electrocoagulation of contaminated liquid in the cell 22, the module(s) 60 may be lifted up and weighed with a conventional weighing device (not shown). If the weight of the module(s) 60 (particularly the weight of the sacrificial metallic material 62) has decreased to a certain value, it may be determined that the module 60 should be replaced in order to optimize effectiveness of the electrocoagulation operation. Also, such weight may be used to determine the volume of remaining sacrificial metallic material 62 in order to calculate current density of power being supplied by the power source 14 to assist in optimizing liquid treatment operations and system efficiency. For another example, the sacrificial metallic material 62 of the module 60 may have a defined and measurable surface area, such as in the embodiment of FIGS. 6 and 12, to help in determining if the module 60 should be replaced. For example, after some duration of electrocoagulation of contaminated liquid in the cell 22, the remaining surface area of the material 62 may be calculated by measuring the change in resistivity across the electrodes 48. Such calculation may be used to determine current density of power being supplied by the power source 14 to assist in optimizing liquid treatment operations and system efficiency.

In another independent aspect, the module(s) 60 may include or provide one or more fluid flow passageways 66 located in or through the gap 52 between the electrodes 48, such as to optimize the surface area of the sacrificial metallic material 62 exposed to contaminated liquid in the gap 52 and/or encourage unobstructed fluid flow thereby or therethrough. The passageways 66 may have any form, configuration and orientation. In some embodiments, the fluid flow passageways 66 are fixed, providing a generally known and generally unrestricted path for fluid passing through the gap 52. In FIG. 3, for example, fluid flow passageways 66 are formed between each of the multiple sacrificial modules 60 and each coil 96 of each such module 60. In FIG. 5, fixed passageways 66 extend through and between the corrugated sheets 68. In FIG. 6, the passageways 66 extend between and around the folds formed by the folded sheets 70, 72. In FIG. 9, the passageways 66 extend between and around the rings 77 of the disc-springs 76. In FIGS. 10 and 11, the fluid flow passageways 66 extend through and between the tubes 80.

If desired, the passageways 66 may be tortuous, such as to increase contact between the contaminated liquid and the sacrificial metallic material 62, and/or increase the agitation of liquid flowing thereby or formation of gas bubbles during electrocoagulation treatment. For example, in FIG. 5, the passageways 66 through the corrugated sheets 68 may be tortuous. For another example, many of the fluid flow passageways 66 extending through the carrier 88 and between and around the freely moving objects 94 in FIG. 14 will be tortuous.

In another independent aspect, the sacrificial modules 60 may be positioned in any desired manner between the electrodes 48. In some embodiments, the module(s) 60 may not be in direct contact with either or both electrodes 48. In the embodiment of FIG. 1, for example, the module 60 does not directly contact the electrodes 48, but is of sufficient distance between the electrodes 48 to receive the electric current passing from one electrode 48, through the contaminated liquid and to the other electrode 48 and allow electrocoagulation to occur in the gap 52. For another example, in FIGS. 12 and 13, multiple modules 60 in the form of hollow tubes 86 do not contact the electrodes 48.

In other embodiments, such as the example of FIG. 5, the sacrificial module(s) 60 may be positioned in direct physical contact with one or both of the electrodes 48, such as to improve conductivity of the electrical current through the gap 52 and/or to improve system performance. Similarly, if multiple adjacent modules 60 are disposed between the electrodes 48, then each module 60 may directly contact either an electrode 48 or adjacent module 60. If desired, at least one module 60 may be arranged and configured to prolong its direct physical contact with one or both electrodes 48 as the sacrificial metallic material 62 dissolves during electrocoagulation. For example, the module(s) 60 or sacrificial member(s) 64 thereof may be placed in tension between the electrodes 48, such as in the embodiments of FIGS. 2, 3, 6, 7, 8 and 9. In these embodiments, the coil-spring configured modules 60 (FIGS. 2 and 3), accordion-like configured sacrificial members 64 (FIGS. 6 and 7) and disc spring sacrificial members 64 (FIGS. 8 and 9) may be installed between electrodes 48 in a compressed state. Accordingly, as the sacrificial metallic material 62 of the modules 60 dissolves, the remainder of the modules 60 may expand and remain in contact with the electrodes 48 for at least some time during continuing electrocoagulation treatment.

The sacrificial module(s) 60 or sacrificial member(s) 64 may be oriented in any desired arrangement relative to the electrodes 48, such as to enhance contact of contaminated liquid with the sacrificial metallic material 62 and/or unobstructed fluid flow thereby. For example, the tubes 80 in the embodiment of FIG. 10 are offset relative to one another, while the tubes 80 of FIG. 11 are aligned. In FIG. 12, the modules 60 (tubes 86) are shown arranged vertically relative to the electrodes 48, such as when the flow of contaminated liquid preferably moves through the gap 52 in an upward or downward direction. In FIG. 13, the modules 60 (tubes 86) are shown arranged horizontally relative to the electrodes 48, such as when the flow of contaminated liquid moves through the gap 52 from left to right or vice versa. The horizontal arrangement of the module(s) 60 or sacrificial members 64 may be useful, for example, when the fluid inlet 32 directs fluid sideways into the gap 52 from a side of the reaction chamber 26.

In another independent aspect of the present disclosure, the electrocoagulation system 10 may be used in connection with hydrocarbon exploration and production operations in the treatment of waste fluids produced or recovered during hydrocarbon drilling, production or related operations (e.g. transportation, storage, etc.). These waste fluids may arise, for example, during well stimulation, acid flow back, initial well flow back, completions, acid mine drainage, pipeline maintenance or at another time during operations. These waste fluids, also referred to as produced water, production fluid and waste water, are referred to herein and in the appended claims as “produced water”. In some instances, after treatment of produced water with the electrocoagulation system 10, the resulting water can be reused in other oilfield operations.

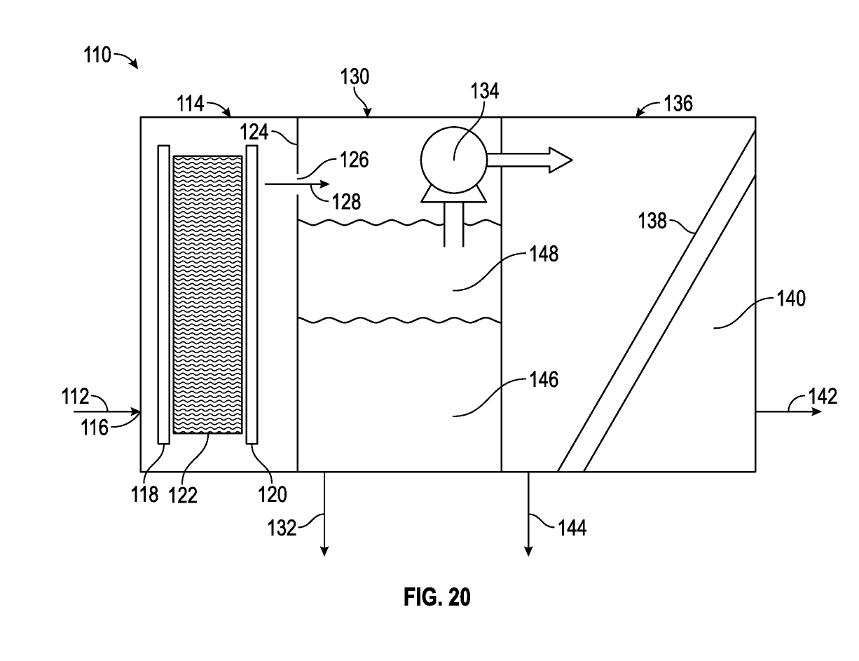

Shown in FIG. 20 is a schematic diagram of the method for at least partially removing boron from untreated water as described herein where the boron removal apparatus is generally shown as 110 where untreated water 112 enters an electrocoagulation (EC) cell 114 at inlet 116. EC cell 114 contains at least two electrodes, an anode 118 and a cathode 120, between which is at least one sacrificial module 122 containing sacrificial metallic material, schematically illustrated inside EC cell 114. These components are described in more detail above. The effluent from EC cell 114 passes through baffle 124 at opening 126 in direction of arrow 128 into settling cell 130, which effluent settles over a period of time (in a non-limiting example between about 10 to about 60 minutes). The settled material 146 may be withdrawn via outlet 132, whereas the top layer 148 is withdrawn via pump 134 and conveyed to filtration cell 136 containing a boron selective polymer resin 138 which removes the boron to give reduced-boron content water 140 (filtrate) that may be withdrawn at outlet 142. If filtration cell 136 needs to be cleaned, for instance if boron selective polymer resin 138 needs to be back flushed, cleaning outlet 144 may be used to remove the flush fluid (typically water).

There may be optionally provided a pre-treatment stage that may suitable include, but not necessarily be limited to activated carbon, a clarifier, a weir tank, a macroreticular resin, filter media, a hydrocyclone, a centrifuge, a coalescer, membrane filtration, and combinations thereof. This optional pre-treatment stage may be placed at any point in the water flow stream prior to boron selective polymer resin. In other words, this pre-treatment stage may be before or after the electrocoagulation apparatus in the process flow. In a particular non-limiting embodiment, the optional pre-treatment stage may suitably be in sequence after the electrocoagulation apparatus and before the boron selective polymer resin. The optional pre-treatment stage may be used to protect the boron selective polymer resin should the electrocoagulation apparatus fail. One goal of the optional pre-treatment stage is to further reduce the hydrocarbon concentration in the effluent.

A goal of using the activated carbon embodiment includes, but is not necessarily limited to, removing or reducing the amount of free chlorine generated by the electrocoagulation apparatus. The form of the activated carbon may include, but is not necessarily limited to, pellets, rods, spheres, powder, granular, and combinations thereof. The size ranges of the activated carbon particles may range from about 1 um independently to about 4 mm; alternatively from about 0.5 mm independently to about 4 mm. The amount of activated carbon used will depend on the desired flow rate of the system, but one acceptable rule of thumb would be a 1:1 volume ratio with the boron selective polymer resin. The weight ratio may be as low as 3:4 activated carbon:boron selective polymer resin, and higher ratios than 1:1 are possible, but are not expected to offer much of an advantage. In one non-limiting embodiment the flow rate of the untreated water containing boron may be about 500 gallons per minute (gpm) (about 1900 liters per minute) using about 300 ft³ (about 8.5 m³) of boron selective polymer resin and approximately 225 ft³ (about 6.4 m³) of activated carbon.

Macroreticular ion exchange resins are defined herein as made of two continuous phases—a continuous pore phase and a continuous gel polymeric phase. The polymeric phase is structurally composed of small spherical microgel particles agglomerated together to form clusters, which, in turn, are fastened together at the interfaces and form interconnecting pores. The surface area arises from the exposed surface of the microgel glued together into clusters. Macroreticular ion exchange resins may be made with different surface areas ranging from 7 to 1500 m²/g, and average pore diameters ranging from about 50 to about 1,000,000 angstroms.

The invention will now be described with respect to particular embodiments of the invention which are not intended to limit the invention in any way, but which are simply to further highlight or illustrate the invention.

### Example 1

### Boron Removal from Synthetic Water Sample

### Water Samples:

Synthetic water sample 1 was prepared by adding calcium chloride (CaCl₂), magnesium chloride (MgCl₂), strontium chloride (SrCl₂), sodium tetraborate (Na₂B₄O₇.10H₂O) and sodium chloride (NaCl), into tap water. No oil was in sample 1. The ion concentration was analyzed with Inducted Coupled Plasma (ICP). The water chemistry of sample 1 is shown in Table II.

Water sample 2 was prepared by adding commercial motor oil into water sample 1. Concentration of Ca²⁺, Mg²⁺, Sr, and B for samples 1 and 2 are the same and total dissolved solids (TDS). Oil and grease concentration was analyzed with a Wilks Model HATR-21 Infra-Red Spectrometer (using n-Hexane extraction method). The water chemistry of sample 2 is also shown in Table II. The oil and grease contents of those water samples that contained oil and grease are considered high.

Water sample 3 was electrocoagulation-treated water sample 2: water sample 2 was treated with electrocoagulation with 4 minutes residence time. The amperage was 50 A, and voltage was 15.2 V. The sample settled down for up to 60 minutes, and the top clear water (sample 3) was collected for analysis and for boron removal testing. The chemistry of sample 3 is shown in Table II.

The electrocoagulation was equipped with non-consumable material as cathode and anode, and aluminum material was loaded into treatment cell, as described above.

TABLE II
Chemistry of Water Samples

| | Sample 1 | Sample 2 | Sample 3 |
|---|---|---|---|
| B (mg/L) | 149 | 148 | 82.5 |
| Ca (mg/L) | 521 | 525 | 490 |
| Mg (mg/L) | 220 | 223 | 71.6 |
| Sr (mg/L) | 220 | 218 | 198 |
| Na (mg/L) | 25,800 | 25,600 | 23,000 |
| Oil and grease (mg/L) | 0 | 355 | 15 |
| Total suspended solids (mg/L) | <10 | <10 | <10 |
| pH | 7.44 | 7.71 | 7.61 |

### Boron Removal Testing:

A commercial boron selective resin was used as it is for boron removal testing from water sample 1, water sample 2, and water sample 3, respectively.

The testing was conducted at room temperature and normal air pressure. The amounts of PUROLITE S110 (or RESINTECH SIR150) resin of 0.5 g, 1.0 g, 1.5 g, 2.0 g, 2.5 g, 3.0 g and 5.0 g were each transferred to 200 ml glass containers respectively, and then 100 ml of sample 1 was transferred into each of 200 ml glass containers containing the resin. A 1 inch (2.54 cm) magnetic bar was used to mix the solution at 700 rpm for 10 minutes. After 10 minutes, the water was filtered with a 0.45 μm membrane for analysis of boron and other metal ion concentration with ICP.

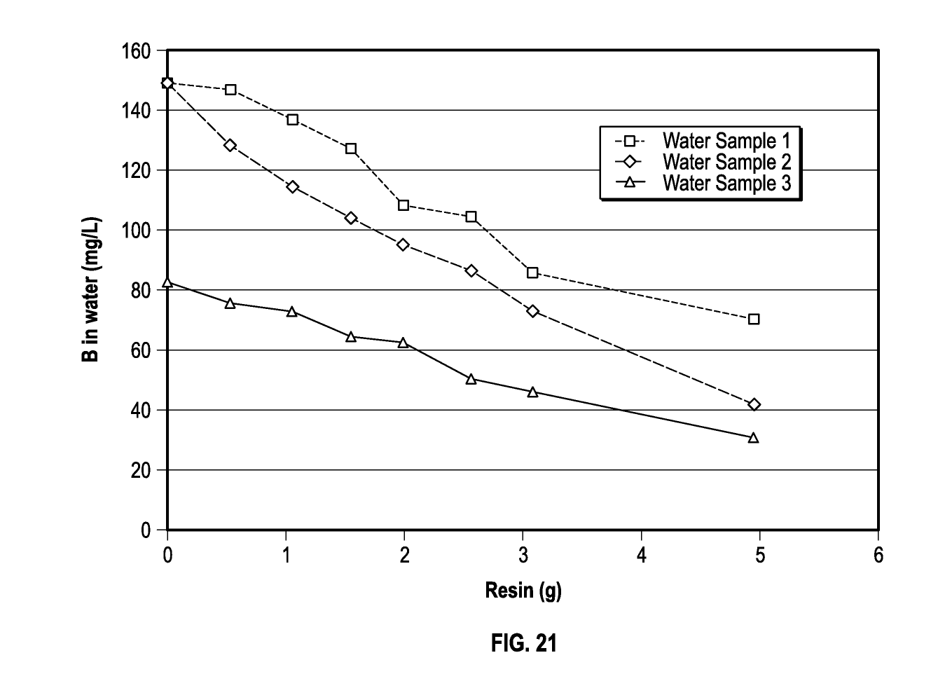

The above testing was repeated with water sample 2, and water sample 3. Boron removal from the three water sample results is illustrated in the graph of FIG. 21.

It is apparent that the boron concentration in water sample 2 is higher than that in water sample 1 for same amount of boron resin.

Electrocoagulation treatment lowered the boron concentration in water sample 2 from 148 mg/L to 82.4 mg/L, and lowered oil and grease from 355 mg/L to 15 mg/L. With same amount of resin, the boron concentration in water sample 3 was much lower than that in water sample 1 and water sample 2.

### Example 2

### Boron Removal from Produced Water Sample

The produced water sample has high concentration of metal ions, suspended solids, oil, and boron. The chemistry is presented in Table III. The water sample was treated with electrocoagulation for 4 minutes, and then filtered with 25 μm filter paper. The filtered sample was analyzed for ion concentration and oil concentration with the method as described in Example 1. The pH of the electrocoagulation treated and filtered water was adjusted with 50% NaOH to around 7 from 4.5.

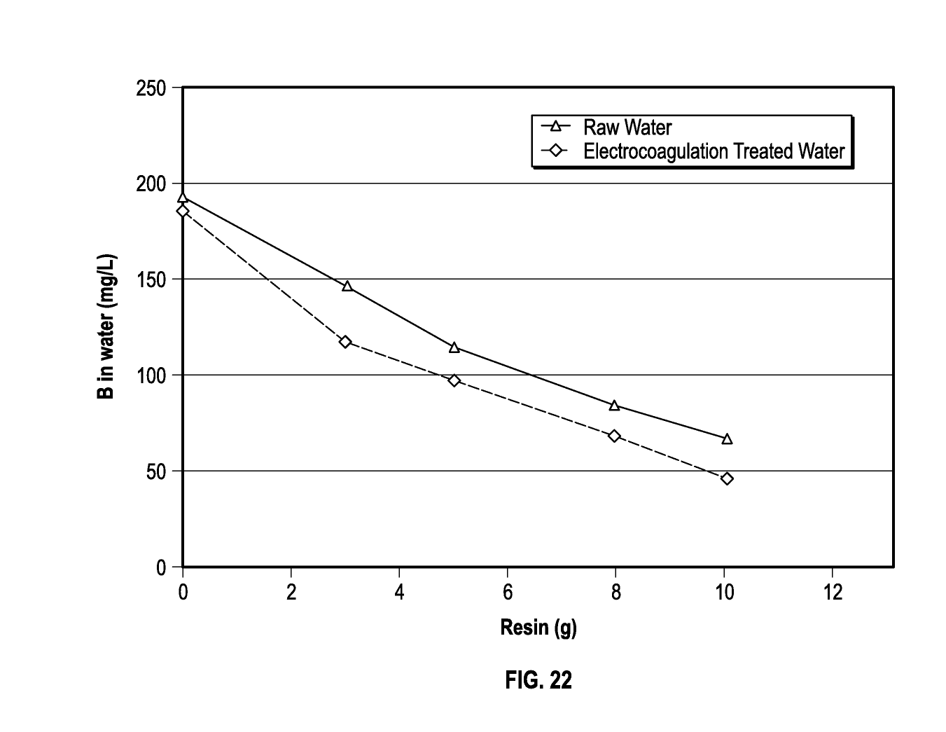

The raw produced water and electrocoagulation treated water was tested for boron removal with same commercial resin used in Example 1, using the method described in Example 1, but the mixing time was 15 minutes. The resin amount for 100 ml of the tested water was 3, 5, 8 and 10 grams, respectively. The boron concentration in both samples after treatment with resin was illustrated in FIG. 22.

Table III showed that electrocoagulation lowered the concentration of oil and some metal ions, such as Fe, Mn, and suspended solids. The boron concentration did not show much difference.

FIG. 22 showed lower boron concentration in the electrocoagulation treated water than that in raw water, indicating that electrocoagulation increased the boron removal efficiency.

Table IV showed the time for boron sorption into the resin to reach sorption equilibrium, where the resin amount was 8 gram for 100 ml water samples, which indicated that there was faster sorption of boron into the resin from electrocoagulation treated water than from raw water.

It was also observed that oil was attached onto the resin surface after treatment from raw water; it may be understood that accumulation on the resin surface after treatment with large volume of oil water could further reduce the boron removal efficiency.

TABLE III
Chemistry of Produced Water Sample Before and After Treatment

| | Raw water | EC treated and filtered |
|---|---|---|
| B (mg/L) | 192 | 185 |
| Ca (mg/L) | 15500 | 14400 |
| Mg (mg/L) | 1210 | 1180 |
| Sr(mg/L) | 981 | 909 |
| Na (mg/L) | 75800 | 72900 |
| Fe (mg/L) | 125 | 3.57 |
| Oil and grease (mg/L) | 195 | 4 |
| Total suspended solids (mg/L) | 1240 | 14 |
| pH | 6.2 | 4.15 |

TABLE IV
Boron Sorption Time into Resin

| | Time to reach sorption |
|---|---|
| | equilibrium(min.) |
| Raw water | 10 |
| Electrocoagulation treated water | 7 |

### Example 3

### Boron Removal from Produced Water Sample (Column Testing)

The produced water sample in this Example had 145 mg/L boron and other metal ions as shown in Table V. The water sample pH was adjusted to 7.3 and then treated with electrocoagulation for 4 minutes, and then filtered with 25 μm filter paper. The filtered sample was analyzed for ion concentration and oil concentration with the method described in Examples 1 and 2.

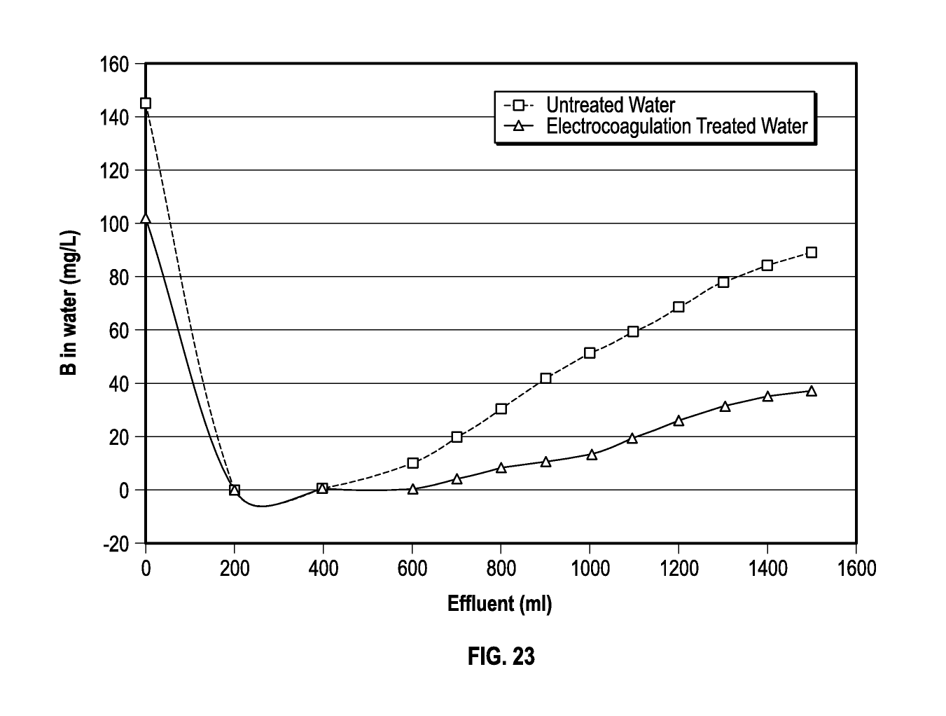

Column testing was conducted for boron removal from the untreated produced water and electrocoagulation treated water. A water sample was pumped into a chromatography column (ACE #15, 15 MM ID 300 MM length) filled with 50 ml boron selective resin at 37 ml/min flow rate. The effluent coming from column was collected and analyzed with ICP for boron concentration. FIG. 23 presents a graph illustrating boron concentration changes at different effluent volume, which showed that electrocoagulation treated water has much lower boron concentration than untreated water when effluent volume was over 400 ml. The results further confirmed that electrocoagulation as pretreatment may increase boron removal efficiency using boron selective resin.

TABLE V
Chemistry of Produced Water Sample
Before and After EC Treatment

| | Raw water | EC treated and filtered |
|---|---|---|
| B (mg/L) | 145 | 102 |
| Ca (mg/L) | 202 | 151 |
| Mg (mg/L) | 180 | 84.6 |
| Sr(mg/L) | 24.4 | 19.9 |
| Na (mg/L) | 5600 | 4960 |
| Fe (mg/L) | 10.7 | 0.20 |
| Oil and grease (mg/L) | 67 | 20 |
| Total suspended solids (mg/L) | 190 | <10 |
| pH | 5.65 | 5.95 |

There are known systems and methods that have been developed for reclaiming water contaminated with the expected range of contaminants typically associated with produced water, including water contaminated with slick water, methanol and boron, including, but not necessarily limited to those described in U.S. Pat. No. 8,105,488. The systems described in this patent are complex and include anaerobically digesting the contaminated water, followed by aerating the water to enhance biological digestion. After aeration, the water is separated using a flotation operation that effectively removes the spent friction reducing agents and allows the treated water to be reclaimed and reused as fracturing water, even though it retains levels of contaminants, including boron and methanol, which would prevent its discharge to the environment under existing standards. The treated water may further be treated by removing the methanol via biological digestion in a bioreactor, separating a majority of the contaminants from the water by reverse osmosis and removing the boron that passes through the reverse osmosis system with a boron-removing ion exchange resin.

In one non-limiting embodiment, the method and apparatus herein independently have an absence of a reverse osmosis system, an absence of an API separator, an absence of an anaerobic treatment stage, an absence of an aeration stage, an absence of a dissolved-air flotation (DAF) system, an absence of a sand filter, an absence of a bioreactor, and an absence of a membrane bioreactor, and further do not use consumable electrodes as in the '488 patent. Unlike the method and apparatus described herein, the '488 method and apparatus treats waters having methanol. The '488 method and apparatus also treats water having relatively low hardness, whereas the present method and apparatus may treat water having relatively high hardness, that is having greater than 1000 mg/L hardness. The residence times for the '488 method and apparatus is measured in days, such as 50 days or more, as contrasted with the residence time in the present method and invention is measured instead in minutes, for instance 60 minutes or less.

It is to be understood that the invention is not limited to the exact details of construction, operation, exact materials, or embodiments shown and described, as modifications and equivalents will be apparent to one skilled in the art. Accordingly, the invention is therefore to be limited only by the scope of the appended claims. Further, the specification is to be regarded in an illustrative rather than a restrictive sense. For example, specific combinations of electrocoagulation apparatus, electrodes and sacrificial materials used therein, boron selective polymer resins, untreated waters, treatment conditions, and the like, falling within the claimed parameters, but not specifically identified or tried in a particular method or apparatus, are anticipated to be within the scope of this invention.

The terms “comprises” and “comprising” in the claims should be interpreted to mean including, but not limited to, the recited elements.

The present invention may suitably comprise, consist or consist essentially of the elements disclosed and may be practiced in the absence of an element not disclosed. For instance, there may be provided a method of at least partially removing boron from untreated water, where the method consists essentially of or consists of treating the untreated water with an electrocoagulation apparatus to give an effluent, and treating the effluent with a boron selective polymer resin to give reduced-boron content water.

In another non-limiting embodiment there may be provided a system for at least partially removing boron from untreated water, where the system consists essentially of or consists of an electrocoagulation apparatus that consists essentially of or consists of at least one inlet configured to allow untreated water to flow into the apparatus, at least one outlet configured to allow an effluent to flow from the housing, first and second electrodes disposed within the apparatus between the at least one inlet and the at least one outlet and spaced apart from one another, each of said first and second electrodes being directly connected to a source of electric power, and a sacrificial module having multiple fluid flow passageways therein, being configured to be positioned in the apparatus between said first and second electrodes and not directly connected to a source of electric power, the sacrificial module including sacrificial metallic material that dissolves during electrocoagulation treatment of the untreated water and being configured to be movable into and out of said housing as a single unit, and where the system also consists essentially of or consists of a boron selective polymer resin having an inlet to receive the effluent from the electrocoagulation apparatus and an outlet to give reduced-boron content water.

What is claimed is:

1. A method of at least partially removing boron from untreated water containing boron, the method comprising:
treating the untreated water with an electrocoagulation apparatus to give an effluent; and
treating the effluent with a boron selective polymer resin to give reduced-boron content water.

2. The method of claim 1 where the untreated water contains more than about 100 mg/L boron and the reduced-boron content water contains less than about 50 mg/L boron.

3. The method of claim 2 where the reduced-boron content water contains less than about 10 mg/L boron.

4. The method of claim 1 where the untreated water is selected from the group consisting of ground water, waste water, irrigation water, industry water, oilfield produced water, and flowback water from hydraulic fracturing fluids selected from the group consisting of slickwater fracturing fluids, linear polymer fracturing fluids, and crosslinked polymer fracturing fluids; and combinations thereof.

5. The method of claim 1 where the electrocoagulation apparatus comprises electrodes that are non-consumable.

6. The method of claim 5 where the non-consumable electrodes comprise noble metal-coated titanium.

7. The method of claim 5 where the electrocoagulation apparatus further comprises a sacrificial metal selected from the group consisting of aluminum, iron, magnesium, mixtures of these metals with other metals, and alloys of these metals with other metals.

8. The method of claim 1 where the boron selective polymer resin has an average particle size between about 300 and about 1200 microns, and where the boron selective polymer resin comprises polystyrene crosslinked with divinylbenzene, where the resin has a coating of n-methylglucamine.

9. The method of claim 1 where the method has a total residence time of less than 60 minutes.

10. The method of claim 1 where the electrocoagulation apparatus comprises at least one first electrode and at least one second electrode, and where the method comprises treating the untreated water with an electrocoagulation apparatus with a voltage between the electrodes of up to 200 volts and a current between the electrodes of up to 1000 amps.

11. The method of claim 1 where the electrocoagulation apparatus comprises:
a housing;
at least one inlet configured to allow fluid flow into said housing;
at least one outlet configured to allow fluid flow out of said housing;
first and second electrodes disposed within said housing between at least one said inlet and at least one said outlet and spaced apart from one another, each of said first and second electrodes being directly connected to a source of electric power; and
a sacrificial module having multiple fluid flow passageways therein, being configured to be positioned in said housing between said first and second electrodes and not directly connected to a source of electric power, said sacrificial module including sacrificial metallic material that dissolves during electrocoagulation treatment of contaminated water in said housing and being configured to be movable into and out of said housing as a single unit.

12. The method of claim 1 further comprising settling the effluent for a period of time between about 10 to about 60 minutes and drawing off a top layer prior to treating the effluent with the boron selective polymer resin.

13. The method of claim 1 further comprising, before treating the effluent with a boron selective polymer resin, a pre-treatment step selected from the group consisting of treating the effluent with activated carbon, treating the effluent with a clarifier, treating the effluent with a weir tank, treating the effluent with a macroreticular resin, treating the effluent with a filter media, treating the effluent with a hydrocyclone, treating the effluent with a centrifuge, treating the effluent with a coalescer, treating the effluent with membrane filtration, and combinations thereof.

14. A method of at least partially removing boron from untreated water containing boron, the method comprising:
treating the untreated water with an electrocoagulation apparatus to give an effluent, where the electrocoagulation apparatus comprises electrodes that are non-consumable and further comprises a sacrificial metal selected from the group consisting of aluminum; iron, magnesium, mixtures of these metals with other metals, and alloys of these metals with other metals, and
treating the effluent with a boron selective polymer resin to give reduced-boron content water,
where the untreated water contains more than about 100 mg/L boron and the reduced-boron content water contains less than about 50 mg/L boron.

15. A system for at least partially removing boron from untreated water containing boron, the system comprising:
an electrocoagulation apparatus comprising:
at least one inlet configured to allow untreated water to flow into the apparatus;
at least one outlet configured to allow an effluent to flow from the apparatus;
first and second electrodes disposed within the apparatus between the at least one inlet and the at least one outlet and spaced apart from one another, each of said first and second electrodes being directly connected to a source of electric power; and
a sacrificial module having multiple fluid flow passageways therein, being configured to be positioned in the apparatus between said first and second electrodes and not directly connected to a source of electric power, the sacrificial module including sacrificial metallic material that dissolves during electrocoagulation treatment of the untreated water and being configured to be movable into and out of said apparatus as a single unit; and
a boron selective polymer resin having an inlet to receive the effluent from the electrocoagulation apparatus and an outlet to give reduced-boron content water.

16. The system of claim 15 where the electrocoagulation apparatus comprises electrodes that are non-consumable.

17. The system of claim 16 where the non-consumable electrodes comprise noble metal-coated titanium.

18. The system of claim 16 where the electrocoagulation apparatus further comprises a sacrificial metal selected from the group consisting of aluminum, iron, magnesium, mixtures of these metals with other metals, and alloys of these metals with other metals.

19. The system of claim 15 where the boron selective polymer resin has an average particle size between about 300 and about 1200 microns, and the boron selective polymer resin comprises polystyrene crosslinked with divinylbenzene, where the resin has a coating of n-methylglucamine.

20. The system of claim 15 where the system is configured to have a total residence time of less than 30 minutes.

21. The system of claim 15 further comprising a pre-treatment stage selected from the group consisting of activated carbon, a clarifier, a weir tank, a macroreticular resin, filter media, a hydrocyclone, a centrifuge, a coalescer, membrane filtration, and combinations thereof, where the pre-treatment stage is present in the system before the boron selective polymer resin.
